(19) United States
(12) Patent Application Publication
(10) Pub. No.: US 2005/0246055 A1
(43) Pub. Date: Nov. 3, 2005

(54) METHOD AND SYSTEM FOR PROVIDING DYNAMIC VERIFICATION AND ALIGNMENT OF PRODUCTION TOOL LOADPORTS

(75) Inventors: RAY A. REYES, NEW WINDSOR, NY (US); ULDIS A. ZIEMINS, POUGHKEEPSIE, NY (US)

Correspondence Address: CANTOR COLBURN, LLP, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 10/709,317

(22) Filed: Apr. 28, 2004

(51) Int. Cl. G06F 7/00

(52) U.S. Cl. 700/213

(57) ABSTRACT

Exemplary embodiments of the invention include a method and system for providing dynamic verification and alignment of production tool loadports in an automated material handling system environment. The method includes transmitting light beams from a production tool loadport fixture to an overhead transport vehicle, reading values received from the light beams by a detector mounted on the overhead transport vehicle, calculating an offset value as a result of reading the values, and adding an identification for the production tool to a tool map. The method also includes adding the offset value for the production tool to the tool map and compensating for the offset values without taking the production tool offline by aligning the overhead transport vehicle with the production tool loadport fixture in accordance with the offset value.

### BACKGROUND OF INVENTION

The present invention relates generally to manufacturing production systems, and more particularly, to a method and system for providing dynamic verification and alignment of production tool loadports in an automated material handling system (AMHS) environment.

The efficiency of a manufacturing enterprise depends, in part, on the quick flow of information and process execution across a complete supply chain. Advancements in shop-floor activities include the automation of production equipment, material processing, material control systems, and the integration of these systems with a host manufacturing execution system (MES). Automating manufacturing processes for certain industries presents many challenges. Unlike the automotive industry, for example, which employs standard assembly-line processing techniques, the manufacture of semiconductor materials in an electronics industry generally involves non-linear processing techniques and frequent changes to production tools that are introduced to the AMHS.

Existing AMHS systems operate with a tool introduction constraint, as well as a periodic verification constraint for active tools. Also, as part of ongoing preventative fabrication (fab) tool maintenance, loadports on fab tools are continuously being swapped, modified, and removed, resulting in degradation of the original taught alignment of the loadport to the AMHS. In order to perform calibrations for these tools, the OHT system is taken offline, resulting in the loss of valuable production time.

What is needed therefore, is a way to verify and align tool loadports while minimizing the production system's downtime.

### SUMMARY OF INVENTION

Exemplary embodiments of the invention relate to a method and system for providing dynamic verification and alignment of production tool loadports in an automated material handling system (AMHS) environment. The method includes transmitting light beams from a production tool loadport fixture to an overhead transport vehicle, reading values received from the light beams by a detector mounted on the overhead transport vehicle, calculating an offset value as a result of reading the values, and adding an identification for the production tool to a tool map. The method also includes adding the offset value for the production tool to the tool map and compensating for the offset values without taking the production tool offline by aligning the overhead transport vehicle with the production tool loadport fixture in accordance with the offset value.

A system for providing dynamic verification and alignment of production tool loadports in an automated material handling system (AMHS) environment includes an overhead transport vehicle transportable via an overhead transport rail, a detector mounted on the overhead transport vehicle, and a production tool that includes a loadport. The system also includes a loadport fixture mounted on the loadport. The loadport fixture includes a plurality of light sources, a communications means, and hardware logic. The plurality of light sources transmit light beams from the loadport fixture to the overhead transport vehicle. The detector reads values received from the light beams and calculates an offset value operable for compensating for the identified offset without taking the production tool offline.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram of an AMH system upon which the alignment tool may be implemented in exemplary embodiments;

FIG. 2 is a block diagram of a portion of an OHT rail, OHT vehicle, and detectors used by the alignment tool in exemplary embodiments;

FIG. 3 is a flowchart illustrating a process for implementing the alignment tool in exemplary embodiments; and

FIG. 4 is a flowchart illustrating a process for implementing the alignment tool in alternate embodiments.

### DETAILED DESCRIPTION

The alignment tool of the present invention resolves the issues of lost production time by providing an in-situ calibration and teaching tool for production tools introduced and/or verified in an automated material handling system (AMHS) environment. The invention includes a light calibration and teaching unit that is composed of a light source and detector, which together determine the relative position and corresponding offset from the tool's delivery point to the overhead transport unit.

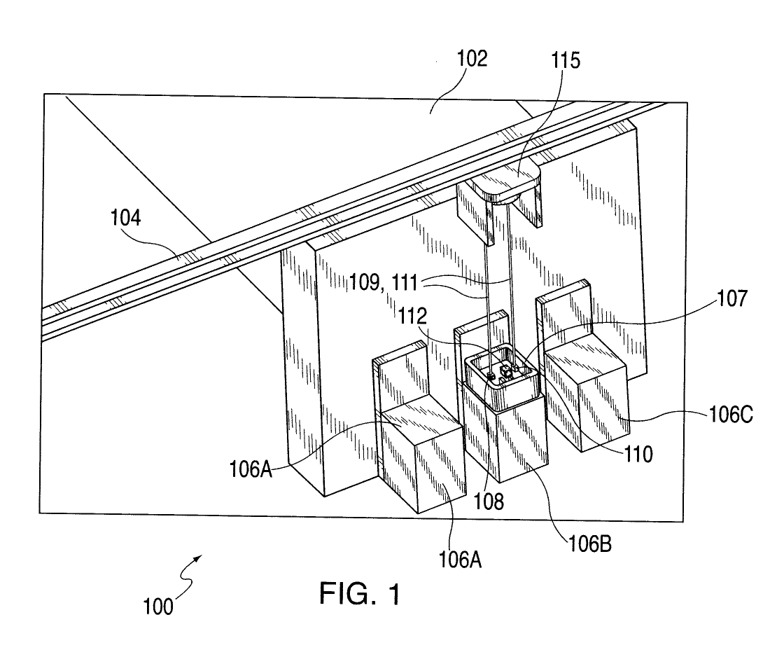

Referring now to FIG. 1, a portion of an AMH system 100 is shown. AMH system 100 includes a production tool 102 coupled to an overhead transport (OHT) rail 104. Production tool 102 includes loadports 106A-C. Loadports 106A-C enable material carrier delivery through a manufacturing facility or bay. For example, in a semi-conductor manufacturing environment, loadports 106A-C may be used to receive wafer carriers, frame carriers, and other similar items. Loadports 106A-106C are preferably SEMI-compliant (i.e., conform to standards set forth by Semi-conductor Equipment and Materials International (SEMI), an organization with established goals to further industry improvement by bringing industry persons together to solve common technical issues).

Load port fixture 107 includes two light sources 108 and 110, a communications device 112 (e.g., wireless modem), and control logic (not shown). The control logic denoted for fixture 107 supplies the means for distributing power via a programmable logic controller (PLC) or process controller (PC) in order to manage the sequence of events needed for the auto alignment process. The control logic also interfaces communications device 112 to the production tool controller and to light sources 108, 110. The control logic is not unique, and is known to those skilled in the art.)

Light sources 108 and 110 may comprise a laser or collimated light source. Light beams 109 and 111 are transmitted via light sources 108 and 110, respectively. Light sources 108 and 110 indicate a relative X, Y, and theta offset of production tool's 102 loadport 106A-C to AMH system's 100 alignment. Although only two light sources 108 and 110 are shown in FIG. 1, it will be understood by those skilled in the art that any additional number of light sources may be utilized by the alignment tool in order to realize the advantages of the invention. Communications device 112 may comprise a wireless modem or other suitable communications means.

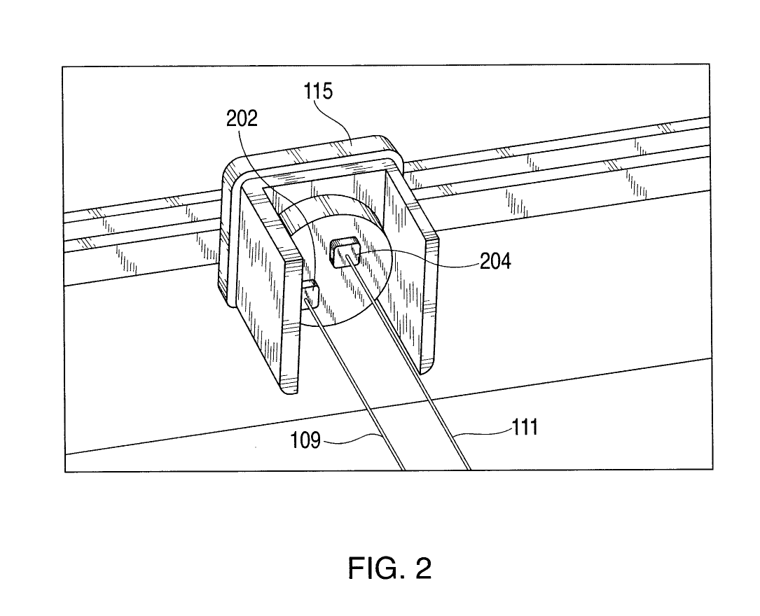

A vehicle 115 is coupled to OHT rail 104 and is shown in greater detail in FIG. 2. Vehicle 115, as depicted in FIG. 2, includes two photon detectors 202 and 204 mounted therein for receiving light beams 109 and 111. Detectors 202 and 204 together are referred to as a charged couple device (CCD) array. Each detector 202 and 204 detects and provides light data from light sources 108 and 110. The location data is used to provide offsets relative to the CCD array. The CCD array preferably possesses the capability to resolve X-Y locations within a 50 mm square area. The two detectors 202 and 204 are aligned to have the same x centerline and are optimally spaced to capture the light beams coming from the vehicle or the loadport, based on selected configuration.

In alternate embodiments, detectors 202 and 204 may be mounted on load port fixture 107. In this embodiment, a means (e.g., mirrors) for reflecting the collimated light from vehicle 115 or its periphery to detectors 202 and 204 would be required.

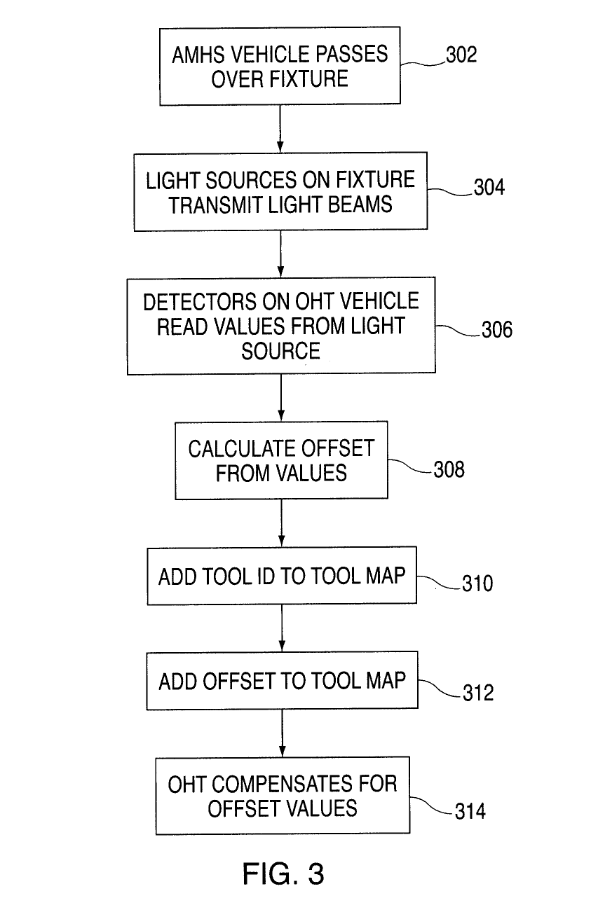

Turning now to FIG. 3, a process for implementing the alignment tool is disclosed. An AMHS vehicle 115 passes over loadport fixture 107 at step 302. Light sources 108 and 110 on loadport fixture 107 transmit light beams 109 and 111, respectively, in the direction of vehicle 115 at step 304. Detectors 202 and 204 on vehicle 115 read the values in-situ that are generated as a result of receiving light beams 109 and 111 at step 306. At step 308, an offset is calculated from these values. The offset is calculated using the actual positions obtained from the detectors. The optimum position is known from a design perspective, and the difference between these two positions are the calculated offset (e.g., incorporating an angle, theta).

Vehicle 115 adds a tool identification to the AMHS' internal tool map at step 310. The tool map represents all possible delivery points for the AMHS OHT. The tool map further encompasses distances between tools, tool functions, tool IDs, and tool offset data.

The offset calculated at step 308 is likewise added to the tool map at step 312 The AMH system 100 directs the OHT to compensate for this offset via an X, Y, and theta stage with respect to the production tool 102 at step 314.

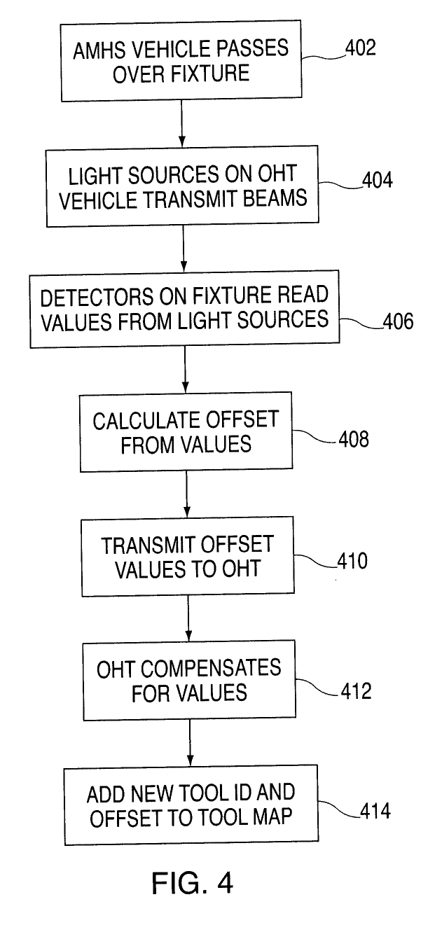

In alternate embodiments, a process for implementing the alignment tool is disclosed in FIG. 4. This process assumes that detectors are located on loadport fixture 107 and that light sources are placed on OHT vehicle 115. At step 402, vehicle 115 passes over loadport fixture 107. Light sources on OHT vehicle 115 transmit light beams in the direction of loadport fixture 107 at step 404. At step 406, detectors on loadport fixture 107 read values generated from light sources 108 and 110. Offset values are then calculated from the values read at step 408. At step 410, the offset values are transmitted to the OHT via communications device 112. The OHT compensates for the offset values with regard to production tool 102 via an X, Y, and theta stage at step 412. At step 414, vehicle 115 internally compensates for the offset and adds the new tool ID and offset to its internal tool map.

As can be seen from the above, the alignment tool allows for dynamic and transparent modification of a fab toolset while eliminating costly downtimes currently associated with tool introductions and verification processes.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing dynamic verification and alignment of production tool loadports in an automated material handling system environment, comprising:
transmitting light beams from a production tool loadport fixture to an overhead transport vehicle, said overhead transport vehicle mounted on an overhead transport rail;
reading values received from said light beams by a detector;
calculating an offset value as a result of said reading values;
adding an identification for said production tool to a tool map;
adding said offset value for said production tool to said tool map; and
compensating for said offset values without taking said production tool offline by aligning said overhead transport vehicle with said production tool loadport fixture in accordance with said offset value.

2. The method of claim 1, wherein said tool map is stored internal to said overhead transport vehicle.

3. The method of claim 1, wherein said light beams are transmitted by a laser.

4. The method of claim 1, wherein said detector is mounted on said overhead transport vehicle.

5. The method of claim 1, wherein said detector is mounted on said production tool loadport fixture; wherein further said overhead transport vehicle includes a reflective device operable for reflecting said light beams from said overhead transport vehicle to said detector.

6. A method for providing dynamic verification and alignment of production tool loadports in an automated material handling system environment, comprising:
transmitting light beams from an overhead transport vehicle to a production tool loadport fixture, said overhead transport vehicle mounted on an overhead transport rail;
reading values received from said light beams by a detector;
calculating an offset value as a result of said reading values;
transmitting said offset value to said overhead transport vehicle; compensating for said offset values without taking said production tool
offline by aligning said overhead transport vehicle with said production tool loadport fixture in accordance with said offset value;
adding an identification for said production tool to a tool map; and
adding said offset value for said production tool to said tool map.

7. The method of claim 6, wherein said offset value is transmitted to said overhead transport vehicle via a wireless modem.

8. The method of claim 1, wherein said detector is mounted on said overhead transport vehicle; wherein further said production tool loadport fixture includes a reflective device operable for reflecting said light beams from said production tool loadport fixture to said detector.

9. The method of claim 1, wherein said detector is mounted on said production tool loadport fixture.

10. A system for providing dynamic verification and alignment of production tool loadports in an automated material handling system environment, said system comprising:
an overhead transport vehicle transportable via an overhead transport rail;
a detector mounted on said overhead transport vehicle;
a production tool comprising a loadport, said production tool engaged with said overhead transport vehicle;
a loadport fixture mounted on said loadport, said loadport fixture including:
a plurality of light sources;
a communications means; and
control logic;
wherein said plurality of light sources transmit light beams from said loadport fixture to said overhead transport vehicle; and
wherein further said detector reads values received from said light beams and calculates an offset value operable for compensating for said offset value without taking said production tool offline.

11. The system of claim 10, wherein said communications means is a wireless modem.

12. The system of claim 1, further comprising a tool map associated with said overhead transport vehicle including delivery points for said overhead transport vehicle, said tool map storing:
a distance between production tools;
production tool identifications; and
production tool offset data.
